(19) United States
(12) Patent Application Publication
(10) Pub. No.: US 2022/0179857 A1
(43) Pub. Date: Jun. 9, 2022

(54) METHOD, APPARATUS, AND SYSTEM FOR PROVIDING A CONTEXT-AWARE LOCATION REPRESENTATION

(71) Applicant: HERE Global B.V., Eindhoven (NL)

(72) Inventors: Srikrishna KOMPELLA, Oak Park, IL (US); Christopher CERVANTES, Chicago, IL (US)

(21) Appl. No.: 17/116,717

(22) Filed: Dec. 9, 2020

(51) Int. Cl. G06F 16/2458; G06N 20/00; G06N 5/02; G06F 16/901

(52) U.S. Cl. CPC G06F 16/2465; G06N 20/00; G06F 40/40; G06F 16/9024; G06N 5/02

(57) ABSTRACT

An approach is provided for a context-aware location representation. The approach, for instance, involves receiving a knowledge graph that represents location entities as location nodes and relationships between the location entities as location edges The approach also involves processing multi-modal data associated with the location entities to determine a plurality of tokens. The approach further involves creating a hypergraph that represents the tokens as token nodes. The hypergraph includes: (1) a first edge type that relates a token node to a location node of the knowledge graph, and (2) a second edge type that relates a first token node to a second token node. The approach further involves selecting a vertex of the hypergraph and performing a random walk to generate a node sequence comprising a subset of one or more nodes of the hypergraph. The approach further involves generating a node embedding based on the node sequence as the context-aware location representation.

### BACKGROUND

Mapping and navigation service providers are making increasing use of machine learning to provide location-based services. Machine learning, for instance, enables service providers to extract underlying spatial and/or semantic relationships between locations and to classify or make predictions based on those relationships or underlying structure. In many cases, the locations can also be associated with unstructured multi-modal data such as text, images, etc. As a result, service providers face significant technical challenges to encode and represent locations along with their semantic/structural relationships and related multi-modal data in a way that can be used for machine learning tasks.

### SOME EXAMPLE EMBODIMENTS

Therefore, there is a need for providing a semantic-aware location representation by, for instance, using distributed representations of multi-modal data-enriched graphs (e.g., text-enriched knowledge graphs).

According to one embodiment, a method comprises receiving a knowledge graph that represents a plurality of location entities as a plurality of location nodes and represents relationship information between the plurality of location nodes as a plurality of location edges. The method also comprises processing multi-modal data (e.g., text and/or image data) associated with the plurality of location entities to determine a plurality of tokens (e.g., words, image objects, etc.). The method also comprises creating a hypergraph (e.g., a temporary enrichment of the knowledge graph) that represents the plurality of tokens as a plurality of token nodes. The hypergraph includes, for instance: (1) a first edge type that relates a token node of the plurality of token nodes to a location node of the plurality of location nodes of the knowledge graph, and (2) a second edge type that relates a first token node to a second token node of the plurality of token nodes. The method further comprises selecting a vertex of the hypergraph that corresponds to a node of either the plurality of token nodes or the plurality of location nodes. The method further comprises performing a random walk of the hypergraph based on the selected vertex to generate a node sequence comprising a subset of one or more nodes of the hypergraph. The method further comprises generating a node embedding (e.g., context-aware location representation) of the node corresponding to the vertex based on the node sequence and providing the node embedding as an output (e.g., for use by downstream machine learning tasks).

According to another embodiment, an apparatus comprises at least one processor, and at least one memory including computer program code for one or more computer programs, the at least one memory and the computer program code configured to, with the at least one processor, cause, at least in part, the apparatus to receive a knowledge graph that represents a plurality of location entities as a plurality of location nodes and represents relationship information between the plurality of location nodes as a plurality of location edges. The apparatus is also caused to process multi-modal data (e.g., text and/or image data) associated with the plurality of location entities to determine a plurality of tokens (e.g., words, image objects, etc.). The apparatus is also caused to create a hypergraph (e.g., a temporary enrichment of the knowledge graph) that represents the plurality of tokens as a plurality of token nodes. The hypergraph includes, for instance: (1) a first edge type that relates a token node of the plurality of token nodes to a location node of the plurality of location nodes of the knowledge graph, and (2) a second edge type that relates a first token node to a second token node of the plurality of token nodes. The apparatus is further caused to select a vertex of the hypergraph that corresponds to a node of either the plurality of token nodes or the plurality of location nodes. The apparatus is further caused to perform a random walk of the hypergraph based on the selected vertex to generate a node sequence comprising a subset of one or more nodes of the hypergraph. The apparatus is further caused to generate a node embedding (e.g., context-aware location representation) of the node corresponding to the vertex based on the node sequence and providing the node embedding as an output (e.g., for use by downstream machine learning tasks).

According to another embodiment, a non-transitory computer-readable storage medium carries one or more sequences of one or more instructions which, when executed by one or more processors, cause, at least in part, an apparatus to receive a knowledge graph that represents a plurality of location entities as a plurality of location nodes and represents relationship information between the plurality of location nodes as a plurality of location edges. The apparatus is also caused to process multi-modal data (e.g., text and/or image data) associated with the plurality of location entities to determine a plurality of tokens (e.g., words, image objects, etc.). The apparatus is also caused to create a hypergraph (e.g., a temporary enrichment of the knowledge graph) that represents the plurality of tokens as a plurality of token nodes. The hypergraph includes, for instance: (1) a first edge type that relates a token node of the plurality of token nodes to a location node of the plurality of location nodes of the knowledge graph, and (2) a second edge type that relates a first token node to a second token node of the plurality of token nodes. The apparatus is further caused to select a vertex of the hypergraph that corresponds to a node of either the plurality of token nodes or the plurality of location nodes. The apparatus is further caused to perform a random walk of the hypergraph based on the selected vertex to generate a node sequence comprising a subset of one or more nodes of the hypergraph. The apparatus is further caused to generate a node embedding (e.g., context-aware location representation) of the node corresponding to the vertex based on the node sequence and providing the node embedding as an output (e.g., for use by downstream machine learning tasks).

According to another embodiment, an apparatus comprises means for receiving a knowledge graph that represents a plurality of location entities as a plurality of location nodes and represents relationship information between the plurality of location nodes as a plurality of location edges. The apparatus also comprises means for processing multi-modal data (e.g., text and/or image data) associated with the plurality of location entities to determine a plurality of tokens (e.g., words, image objects, etc.). The apparatus also comprises means for creating a hypergraph (e.g., a temporary enrichment of the knowledge graph) that represents the plurality of tokens as a plurality of token nodes. The hypergraph includes, for instance: (1) a first edge type that relates a token node of the plurality of token nodes to a location node of the plurality of location nodes of the knowledge graph, and (2) a second edge type that relates a first token node to a second token node of the plurality of token nodes. The apparatus further comprises means for selecting a vertex of the hypergraph that corresponds to a node of either the plurality of token nodes or the plurality of location nodes. The apparatus further comprises means for performing a random walk of the hypergraph based on the selected vertex to generate a node sequence comprising a subset of one or more nodes of the hypergraph. The apparatus further means for comprises generating a node embedding (e.g., context-aware location representation) of the node corresponding to the vertex based on the node sequence and providing the node embedding as an output (e.g., for use by downstream machine learning tasks).

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a semantic-aware location representation, according to one embodiment;

FIG. 2 is a diagram of components of a machine learning system capable of providing a semantic-aware location representation, according to one embodiment;

FIG. 3 is a flowchart of a process for providing a semantic-aware location representation, according to one embodiment;

FIG. 4 is a diagram illustrating an example knowledge graph of locations, according to one embodiment;

FIG. 5 is a diagram illustrating an example of a token graph created from multi-modal data, according to one embodiment;

FIGS. 6A and 6B are diagrams illustrating an example hypergraph of distributed representations of an enriched knowledge graph and an example random walk through the hypergraph, according to one embodiment;

FIG. 7 is a diagram illustrating an example of encoding a sparse feature vector based on a node sequence generated from a random walk of a hypergraph, according to one embodiment;

FIG. 8 is a diagram illustrating an example machine learning model from which node embedding for machine learning tasks can be extracted, according to one embodiment;

FIG. 9 is a diagram illustrating example node embedding data, according to one embodiment;

FIG. 10 is a flowchart of a process for using a node embedding for a machine learning task, according to one embodiment;

FIG. 11 is a diagram illustrating an example neural network capable of using a node embedding, according to one embodiment;

FIG. 12 is a diagram of a geographic database, according to one embodiment;

FIG. 13 is a diagram of hardware that can be used to implement an embodiment of the processes described herein;

FIG. 14 is a diagram of a chip set that can be used to implement an embodiment of the processes described herein; and

FIG. 15 is a diagram of a terminal that can be used to implement an embodiment of the processes described herein.

### DESCRIPTION OF SOME EMBODIMENTS

Examples of a method, apparatus, and computer program for providing a sematic-aware location representation using an enriched knowledge graph are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

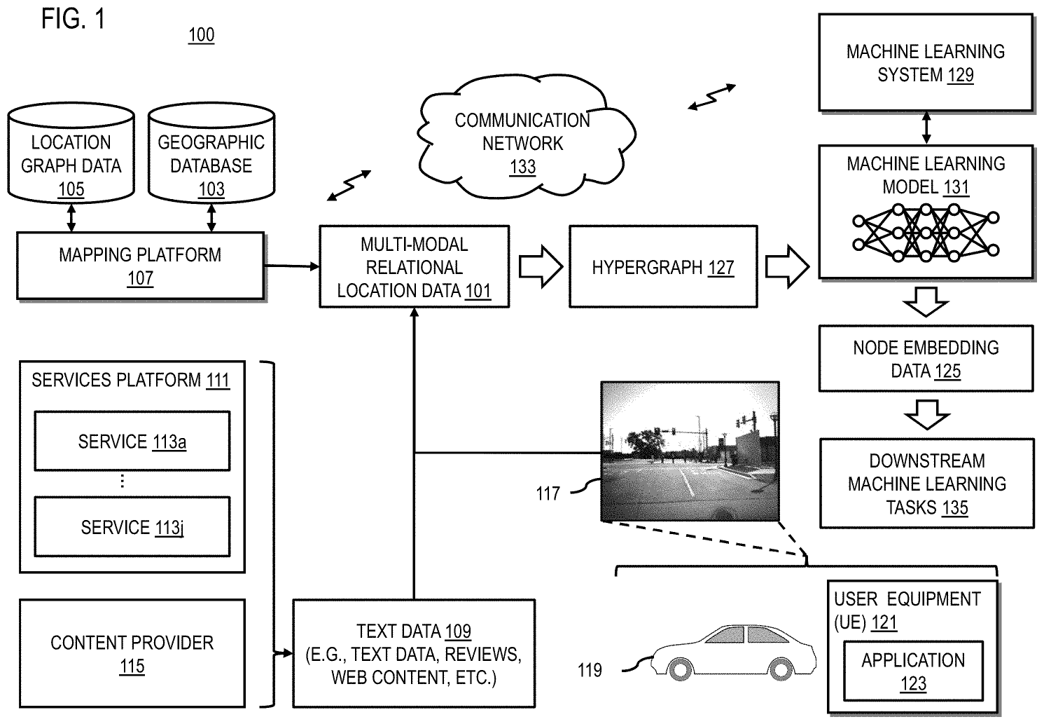

FIG. 1 is a diagram of a system 100 capable of providing a semantic-aware location representation, according to one embodiment. The various embodiments described herein related creating context-aware entity embeddings for graph entities (e.g., nodes). Specifically, the various embodiments can use graph embedding methods that learn to represent nodes based on their neighbors and incorporate external textual data.

In general, graphs can represent interactions between entities. For example, there can be graphs for social networks, transportation systems, protein structures, and so on. Knowledge graphs (KGs), for instance, describe how entities (e.g., physical objects and abstract concepts) relate to one another. They can be used to understand these relationships including, but not limited to represent location-based ontologies (e.g., a set of location-based entities/attributes and the relationships between them). For example, in question answering application use case, the question “Where was the 44th president born?” can be answered by the retrieval of two relational pieces of information that can be represented in a KG: e.g., relational information such as “44th president” SAME_AS “Obama” and “Obama” BORN_IN “Hawaii” that can be represented in a knowledge graph (e.g., SAME_AS and BORN_IN being relationship operators (e.g., edges of the KG) and the terms as the entities or nodes of the KG.

The applications of a location-based ontology are diverse, and include, but are not limited to, search, question answering, and bring your own data (BYOD) cases. Any task that uses a nuanced semantic understanding of locations is a task for which KGs have a role. In order to use machine learning approaches in conjunction with knowledge graphs, however, service providers face significant technical challenges to developing to represent graph entities in a scalable, structure-invariant way. More specifically, for location-based services providers, the technical challenges focus generating graph embeddings that include spatial data (where something is), as well as capture more detailed qualitative information, like what a place is and how it relates to other places (e.g., semantic properties of the location entities). One way to consider these semantic properties is with a knowledge graph (KG), which represents physical or conceptual entities with semantically salient relationships.

In one embodiment, when organized into a KG, locations can be defined by their relationships to conceptual entities (e.g. “Starbucks” TYPE OF “coffee shop”) and by their relationships to one another. These KGs are typically difficult to construct, maintain, and may not contain some important relationships. Moreover, locations are complex entities, and can be described by potentially large quantities of multi-modal data 101 that extend beyond those present in a KG. Examples of multi-modal data 101 and other data of a KG include, but are not limited to: (1) digital map data of a geographic database 103 and/or location graph data 105 provided by a mapping platform 107; (2) text data 109 (e.g., text descriptions, web content, reviews, etc.) provided by a services platform 111, one or more services 113a-113j (also collectively referred to as services 113) of the services platform 111, one or more content providers 115, etc.), image data 117 (e.g., street level imagery provided by vehicles 119 and/or user equipment (UE) devices 121 executing imaging-capable applications 123), and/or any other source of multi-modal relational location data 101 available to the system 100. In fact, the more well-formed the KG (that is, the more restrictive the graph's node and relations), the less able it will be to incorporate arbitrary additional information like unstructured multi-modal relational location data 101 (e.g., text descriptions).

One technical challenge or problem, therefore, is how to incorporate the information that is external to a KG (e.g., text, images, etc.) into the representation of the entities within the KG (e.g., location entities like POIs). Incorporating these arbitrary pieces of information into graph-based methods for location KGs, then, would require complicated data mining techniques that enhance the graph. However, these methods are error prone and require significant effort to implement.

To address these technical challenges, a system 100 of FIG. 1 introduces a capability to produce dense representations (e.g., node embedding data 125) of locations by combining spatial and structured information (e.g., present in a knowledge graph) with unstructured information (e.g., multi-modal relational location data 101 such as web-scraped text) to generate distributed data-enriched graphs (e.g., a hypergraph 127) from which the node embedding data 125 is created. As used herein, the term “hypergraph” refers to a graph enrichment that adds nodes and links to the knowledge graph to represent the words/tokens of the unstructured information and the relationships between the words/tokens. The graph enrichment or hypergraph 127 can be a temporary graph structure that is created for the purpose of generating node embeddings or can be stored for use by other applications or services relying on such hypergraphs.

In one embodiment, the node embedding data 125 can be generated using representation learning techniques and traditional natural language processing tools (e.g., performed by the machine learning system 129 in combination with the machine learning model 131 over a communication network 133) to process the hypergraph 127 and generate the node embedding data 125. In this way, the system 100 can advantageously simplify the how additional unstructured multi-modal relational location data 101 can be incorporated into a sematic-aware location representation (e.g., node embedding). Thus, the approach of the various embodiments described herein can reduce the data and computing resources used for generating node embedding data 125 from multi-modal relational location data 101. In one embodiment, the node embedding data 125 can then be used by downstream machine learning tasks 135 that rely on enriched KGs (e.g., hypergraph 127) as an input.

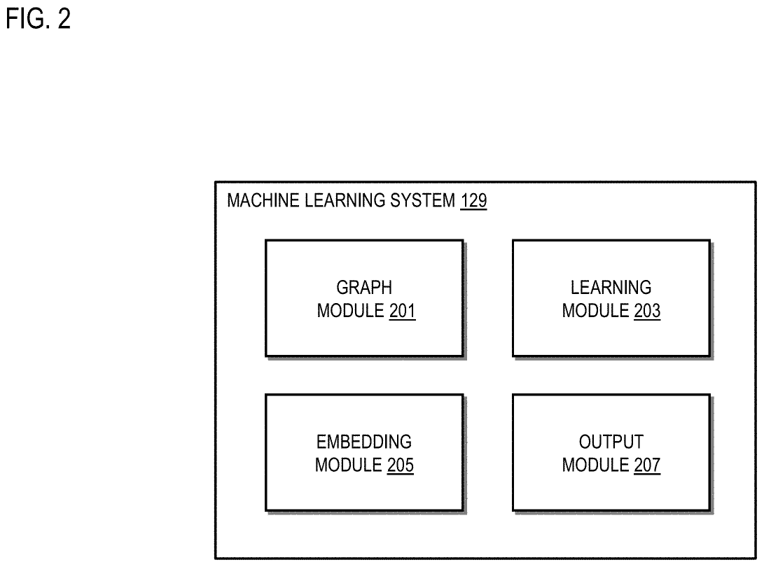

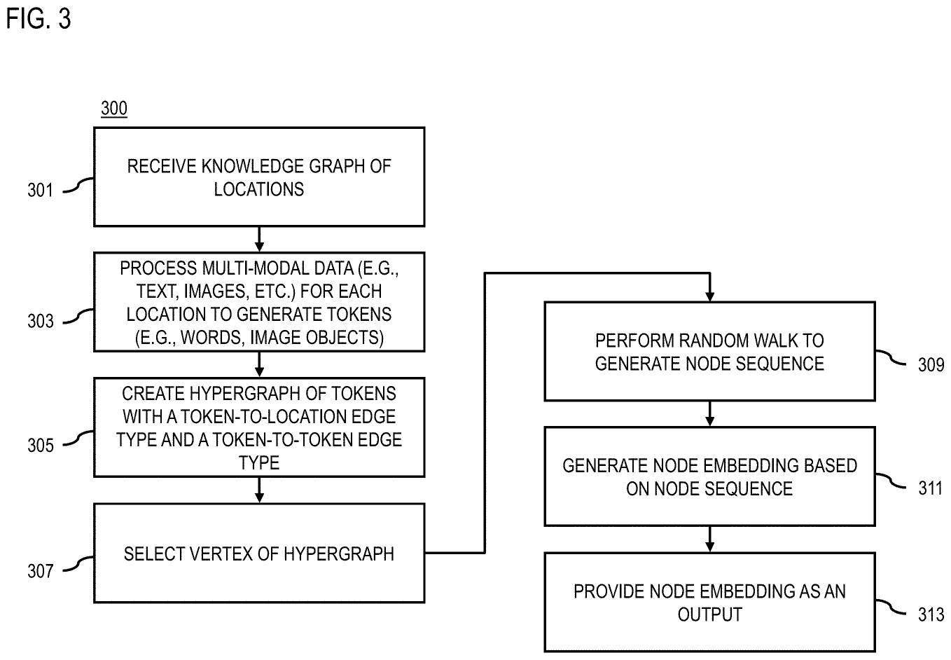

In one embodiment, as shown in FIG. 2, the machine learning system 129 of the system 100 includes one or more components for providing a semantic-aware location representation based on enriched graphs according to the various embodiments described herein. It is contemplated that the functions of the components of the machine learning system 129 may be combined or performed by other components of equivalent functionality. As shown, in one embodiment, the machine learning system 129 includes a graph module 201, a learning module 203, an embedding module 205, and an output module 207. The above presented modules and components of the machine learning system 129 can be implemented in hardware, firmware, software, or a combination thereof. Though depicted as a separate entity in FIG. 1, it is contemplated that the machine learning system 129 may be implemented as a module of any of the components of the system 100 (e.g., a component of the mapping platform 107, services platform 111, services 113, content providers 115, vehicles 119, UEs 121, and/or the like). In another embodiment, one or more of the modules 201-207 may be implemented as a cloud-based service, local service, native application, or combination thereof. The functions of the mapping platform 107 and modules 201-207 are discussed with respect to FIGS. 3-12 below.

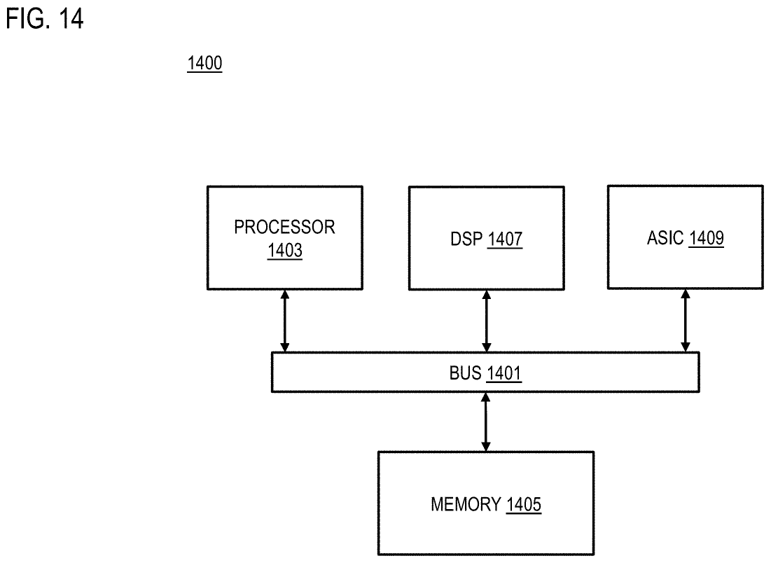

FIG. 3 is a flowchart of a process 300 for providing a context-aware and application/service independent location representation for machine learning tasks, according to one embodiment, according to one embodiment. In various embodiments, the machine learning system 129 and/or any of the modules 201-207 may perform one or more portions of the process 300 and may be implemented in, for instance, a chip set including a processor and a memory as shown in FIG. 14. As such, the machine learning system 129 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the graph model receives or otherwise creates a knowledge graph that represents a plurality of location entities as a plurality of location nodes and represents relationship information (e.g., spatial and/or semantic relationships) between the plurality of location nodes as a plurality of location edges. In one embodiment, a knowledge graph (KG) for locations represents real-world entities that, for instance, are stored the geographic database 103 and/or location graph data 105. In various embodiments, a KG and location graph (e.g., the location graph data 105) are used interchangeably.

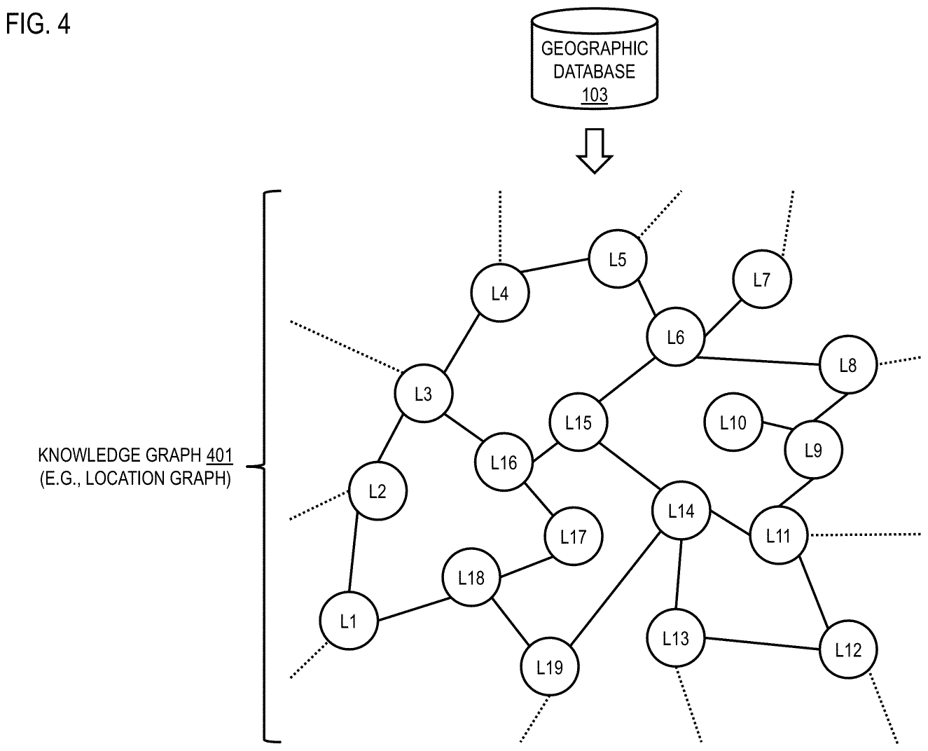

FIG. 4 is a diagram illustrating an example knowledge graph 401 of locations for generating a semantic-aware location representation, according to one embodiment. In the example of FIG. 4, the digital map data of the geographic database 103 can be processed to generate a knowledge graph 401 of location entities (e.g., POIs, places, terrain features, administrative areas, and/or any other stored cartography/map features at any geographic resolution) of the geographic database 103. The knowledge graph 401, for instance, can represent all of the stored location entities of the geographic database 103 or just a portion of the geographic database 103 (e.g., location graph associated with a country, region, city, etc.). As previously discussed, the knowledge graph 401 can model relationships between location entities or objects in a variety of ways. Location entities and their relationships may be described using a set of labels (e.g., entity categories such as restaurant, park, office building, etc.). Location entities or objects may be referred to as “nodes” of the knowledge graph 401 (e.g., represented as circles in FIG. 4) and the “edges” (e.g., represented as lines between nodes in FIG. 4) represent relationships between nodes, where the nodes and relationships among nodes may have data attributes. The organization of the knowledge graph 401 may be defined by a data scheme which defines the structure of the data. The organization of the nodes and relationships may be stored in an ontology (e.g., in the location graph data 105, the geographic database 103, or external data source) which defines a set of concepts where the focus is on the meaning and shared understanding. These descriptions permit mapping of concepts from one domain to another.

In other words, the knowledge graph 401 is a location graph of nodes (e.g., nodes labeled in FIG. 4 as L1-L19 respectively representing 19 different location entities) that are interrelated with relationships between the different nodes. As previously described, in a location graph, the nodes are location entities or objects. For example, a node may be a POI such as a theater. Other nodes may include a first street, a second street, a parking lot, etc. Relationships may interconnect the nodes of the knowledge graph 401, such as a relationship between the theater node and the first street may include a numerical address, where the numerical address is the relationship between the first street and the theater. A parking lot node may be affiliated with the theater node, and the relationship may be an indication of parking available for the theater. The relationship between the second street node and the theater node may include an entrance to the parking lot, such that the second street node is connected to the theater node by way of the parking lot node.

While example embodiments may include location entities as nodes, nodes may take many forms, including an event, for example. An event may be a node that includes a time (date/time), location, event type (e.g., sporting event), etc. That node may be related to the physical location of the event, transportation nodes, or other elements that have a contextual relationship with the event. The relationships or connections amongst the nodes of a location graph may be contextual links, whereby the relationships relate to how a node is connected to another node.

In one embodiment, the data attributes associated with the nodes and/or edges of the knowledge graph 401, may include multi-modal relational location data 101 (e.g., unstructured text data 109, image data 117, etc.). By way of example, the multi-modal relational location data 101 includes geographic location data, relative location data, place category data, imagery data, text data, context data, or a combination thereof associated with the one or more location entities, a geographic area in which the one or more entities are located, or a combination thereof. In one embodiment, the multi-model relational location data 101 can be retrieved from a third-party external semantic data source. As noted above, integrating this unstructured multi-modal data 101 into the knowledge graph presents a significant technical that is addressed by the various embodiments described herein.

Accordingly, in step 303, the graph module 201 processes multi-modal data (e.g., multi-modal relational location data 101 such as unstructured text data 109) associated with the plurality of location entities of the knowledge graph 401 to determine a plurality of tokens (e.g., words of the text data 109, detected image objects of the image data 117, etc.). In other words, most of the location entities of the knowledge graph 401 have associated unstructured text (e.g., from Wikipedia articles, Common Crawl web sites, etc. and/or provided by the service platform 111, services 113, and/or content providers 115).

For example in the use case of unstructured text, incorporating this unstructured text into the KG using data mining and KG construction techniques is resource intensive to point of being infeasible under traditional technologies because of the scale or volumes of available text data 109 or other multi-modal relational location data 101. In addition to issues of scale, KGs typically are highly structured by definition. Therefore, adding poorly defined data (e.g., unstructured text data 109 or equivalent) would weaken the usefulness of the knowledge graph 401 by inducing noise and spurious connections. However, there are still valuable insights that can be drawn from unstructured text data 109 or any other multi-modal relational location data 101 (e.g., image data 117) about a location entity. For example, if two restaurants (e.g., examples of POI entities) have their menus online, the text in those menus may share many words and phrases even if their coarse categories are not the same. Leveraging this text would allow the system 100 or any corresponding service or application to know that the two are conceptually connected even if the KG does not link them in that way.

Therefore, as part of step 303, the graph module 201 can gather text features (e.g., text data 109) and/or other multi-modal relational location data 101 (e.g., image data 117) for individual nodes of the knowledge graph 401. By way of example, gathering can include but is not limited to querying the services platform 111, services 113, and/or content providers 115 for content associated with a location node or entity of interest. In another example, a web crawler or other automated data gathering means can be used to extract information from online web data sources to determine text data 109 and/or other multi-modal relational location information 101 about location entities of interest.

The graph module 201 can then, for instance, process the gathered data to extract tokens (e.g., words, image objects, etc.) from the multi-modal relational location data 101. For example, for gathered text data 109, the graph module 201 can preprocess the text data 109 using a natural language processing (NLP) pipeline or means to extract the tokens as a set of words comprising the text data 109. In one embodiment, the graph module 201 can just extract the tokens identified by the NLP processing pipeline as nouns or other designated parts of speech. In this example, by selecting only the nouns, the graph module 201 can advantageously focus on salient text by removing tokens or words that may be inappropriate tokens (e.g., words related to script tags from web pages).

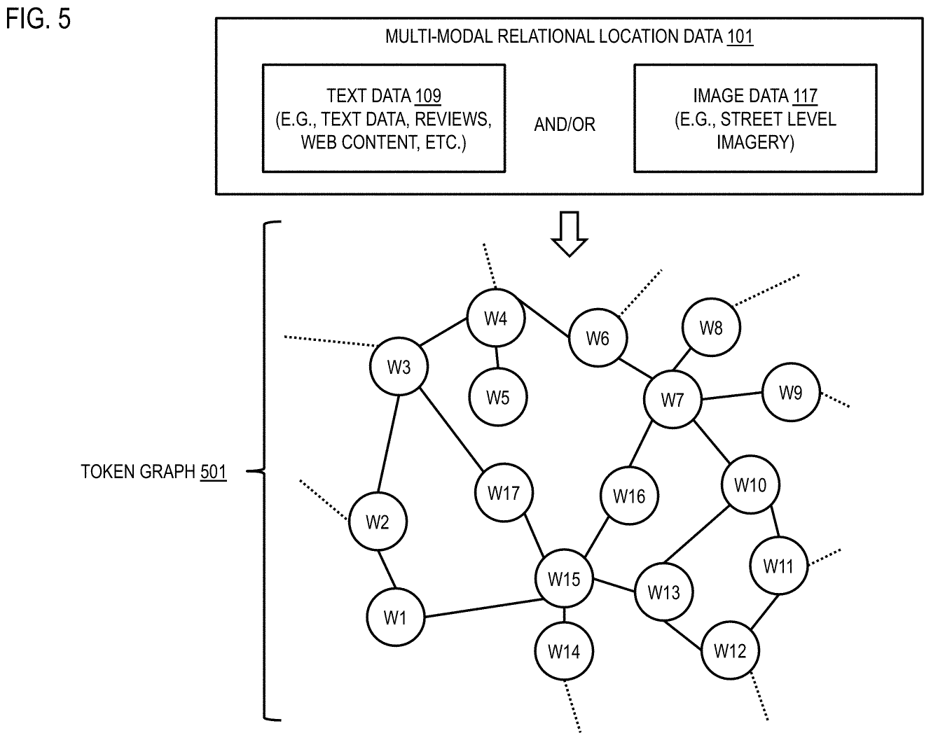

FIG. 5 is a diagram illustrating an example of a token graph 501 created from multi-modal data, according to one embodiment. In the example of FIG. 5, multi-modal relational location data 101 comprising text data 109, image data 117, and/or the like are gathered for a given location entity of interest. In this example, the primary data type is unstructured text data 109 gathered from web pages related to the location entity (e.g., a web page for the location itself, web text related to reviews or articles about the location, etc.). A NLP pipeline is used to process the gathered text data 109 to extract all of the noun words from the text to create the token graph 501 a plurality of token nodes (e.g., labeled in the token graph 501 as W1-W17 to represent an example set of 17 words/tokens). Thus, in the example above, the multi-modal data 101 is unstructured text data 109 such that the plurality of tokens that is extracted is a plurality of words of in the unstructured text data 109.

In one embodiment, the edges between the token nodes of the token graph 501 can represent the determined similarity between the two words. For example, the similarity between any two tokens can be computed using the respective token embeddings of the NLP pipeline used to extract the tokens. In some embodiments, to reduce the processing resource load, the token similarity can be computed for just a designated subset of the entire vocabulary or set of tokens/words in the token graph 501. For example, the graph module 201 can select N random pairs of token nodes and compute the similarity scores (e.g., normalized to a value between 0—not similar—and 1—the same or most similar word) just for those N random pairs.

In the case of other types of multi-modal relational location data 101 such as, but not limited to, image data 117, similar processing pipelines can be applied. For example, image data 117 (e.g., street level imagery) can be processed using any object recognition/detection pipeline or process to detect image objects depicted in the image data. These image objects can be represented as respective tokens in the token graph 501. The relative locations of the image objects can also be detected as well as the similarity of the objects can be computed (e.g., via the same object recognition/detection pipeline) to characterize the relationships or edges between the image objects in the token graph 501.

It is noted that the creation of the token graph 501 is provided by way of illustration and not as a limitation. It is noted that in some embodiments, the graph module can incorporate the creation of the token graph 501 as integral part of creating a hypergraph 127 to enrich the knowledge graph 401 as described in the embodiments below.

In one embodiment, the machine learning system 129 can learn some representation (e.g., a semantic-aware location representation) of each location entity in the knowledge graph 401 such that both the knowledge graph 401's structure and the location entity's external signal (e.g., text or other modalities represented in the token graph 501) are incorporated. Accordingly, in step 305, the graph module 201 creates a hypergraph 127 that represents the plurality of tokens (e.g., extracted from the gathered multi-modal data 101) as a plurality of token nodes (e.g., as described with respect to the token graph 501. The hypergraph includes: (1) a first edge type that relates a token node of the plurality of token nodes to a location node of the plurality of location nodes of the knowledge graph 401, and (2) a second edge type that relates a first token node to a second token node of the plurality of token nodes.

In other words, the graph module 201 creates the semantic-aware location representations (e.g., node embedding data 125) using a hypergraph 127: e.g., a temporary, auxiliary graph that connects nodes of the knowledge graph 401 for the purpose of creating node embeddings (e.g., node embedding data 125). This hypergraph 127 contains nodes representing text or other types of tokens (e.g., “affordable”, “scenic”) and two types of edges: those linking location nodes of the knowledge graph 401 to token nodes, and those linking token nodes together. In one embodiment, the different edge types can also be weighted based on the nodes being connected. For example, for the edge type that connects a token node to a location node, the graph module 201 can weight this edge type based on token frequency data. The token frequency data indicates the frequency that the token appears in the multi-modal data 101 (e.g., text data 109, image data 117, etc.) associated with the location entity to which it is connected. It is contemplated that any metric indicating such token frequency data can be used including, but not limited, to term frequency-inverse document frequency (TF-IDF) value (e.g., normalized to 0-1) or equivalent. The TF-IDF value, for instance, increases proportionally to the number of times the token appears in the multi-modal data 101 gathered for a location entity and is offset by the number of documents in the gathered multi-modal data 101. In one embodiment, the graph module 201 can select the plurality of tokens to include in the hypergraph based on the token frequency data. For example, the graph module 201 can include those tokens (e.g., noun tokens) that have a TF-IDF value above a threshold value.

For the second edge type between a first token and a second token, the graph module 201 can weight the edge based on a token similarity between the two connected tokens. For example, this edge type can be weighed by the cosine similarity score of those tokens' pretrained embeddings. As discussed above, the graph module 201 can reduce the time and/or computing resources for computing token similarity scores by selecting a subset of the tokens for computing a similarity score. In this way, the token similarity value (e.g. normalized to 0-1) can be computed for a predefined number (N) random pairs of the plurality of tokens identified in the gathered multi-modal data 101 for a given location entity.

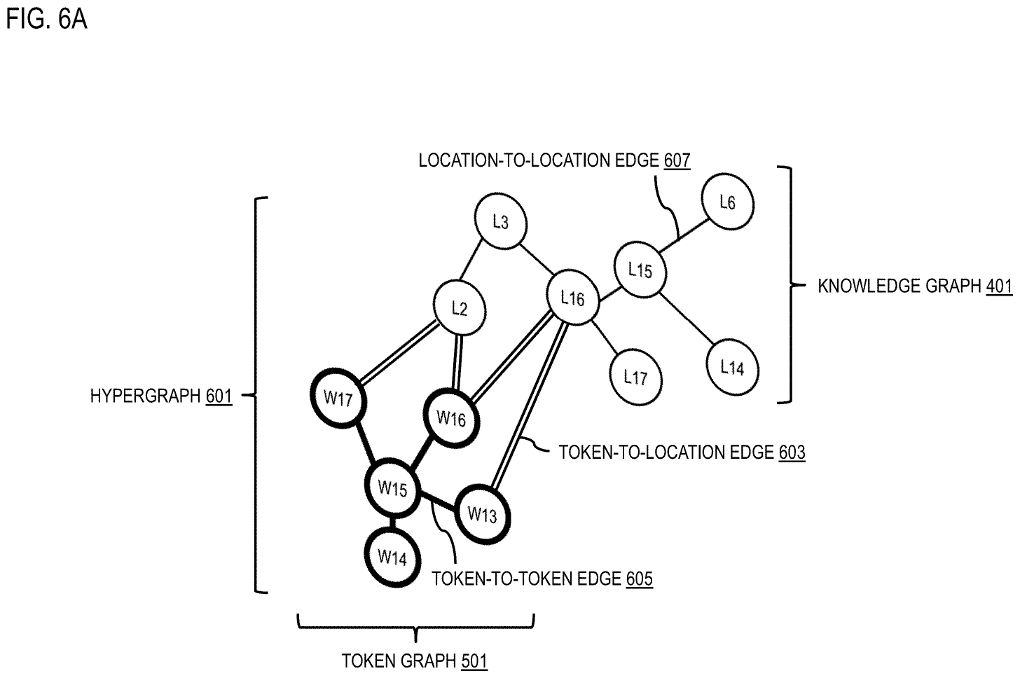

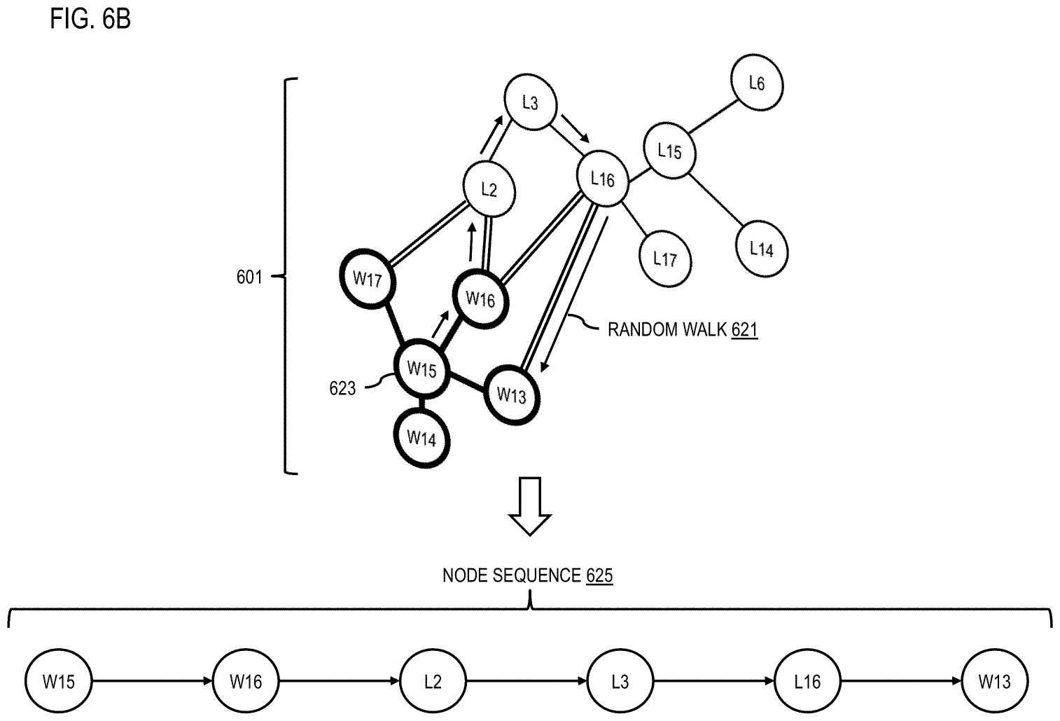

FIG. 6A illustrates an example hypergraph 601, according to one embodiment. As shown, the hypergraph 601 links one or more the locations nodes of the knowledge graph 401 (only a portion of the knowledge graph 401 is depicted for simplicity) and/or or more token nodes of the token graph 501 (only a portion of the token graph 501 is depicted for simplicity). In this way, the hypergraph 601 integrates the spatial or structural information of the knowledge graph 401 with the multi-modal relational location data 101 (e.g., unstructured text data, image data, etc.) of the token graph 501 as a distributed but connected hypergraph. The hypergraph 601 includes a set of tokens W13-W17. Each of the tokens W13-W17 represents a respective word extracted from unstructured text data associated with one or more locations.

The hypergraph 601 then links the tokens W13-W17 to one or more locations of the knowledge graph 401 represented by a set of location nodes {L2, L3, L6, L14-L17} via one or more token-to-location edges 603 (e.g., a first edge type of the hypergraph 601). The token-to-location edge 603 indicates that a token appears in the one or more documents or other data sources gathered for the corresponding location. In one embodiment, the token-to-location edge can be weighted based on the frequency of the token appearing in the documents offset by the number of documents (e.g., a TF-IDF value or equivalent). For example, if a token or word appears frequently in the gather multi-modal data 101 of a location node or entity, then the token TF-IDF value or other frequency value will be higher.

Similarly, the token-to-token edges 605 between a first token and a second token in the hypergraph 601 can also be weighted. In this case, the weighting can be based on a similarity value between the two connected tokens (e.g., as computed by a trained NLP pipeline or process using pretrained token embeddings). More specifically, in one embodiment, the weighting can be computed as a cosine similarity between the respective pretrained token embeddings of the two tokens.

In the illustrated example of FIG. 6A, the location-to-location edges 607 connecting any two location entities of the knowledge graph 401 can also be weighted. The weighting can be based on spatial proximity (e.g., 0-1 representing a spatial distance) and/or semantic proximity (e.g., 0-1 representing distance between the semantic features of the location entities).

In summary, the graph module 201 constructs a hypergraph 127 (e.g., as illustrated by the example hypergraph 601) that enriches the knowledge graph 401 with the multi-modal relational location data 101 for each location entity. To do this, in one embodiment, the hypergraph 127 provides both token-to-location edges and token-to-token edges to define a distributed enriched knowledge graph. Accordingly, each vertex or node of the hypergraph 127 can be either a token node or location node.

After creating the hypergraph 127, in step 307, the graph module selects a vertex of the hypergraph that corresponds to a node of either the plurality of token nodes or the plurality of location nodes. In one embodiment, the selected vertex can be associated with a location entity of interest for which node embedding data 125 is be generated or a token node associated with the location entity. In step 309, the graph module 201 performs one or more random walks of the hypergraph based on the selected vertex to generate a node sequence comprising a subset of one or more nodes and one or more edges of the hypergraph. In other words, the graph module 201 runs one or more random walks to generate an artificial corpus of node sequences related to a selected node or vertex of the hypergraph.

In one embodiment, the random walk is biased based on the one or more edge weight values of the one or more edges of the hypergraph traversed during the random walk. For example, the edge weights can be used to adjust the probability of the random walk traversing one of the possible paths at each vertex such that edges with higher weights have a higher probability begin chosen on the random walk than edges with lower weights.

FIG. 6B illustrates a random walk 621 through a hypergraph 601, according to one embodiment. In the example of FIG. 6B, a vertex 623 (e.g., token node W15) is selected as the starting point of the random walk 621 (e.g., indicated by a sequence of arrow between nodes of the hypergraph). Beginning at selected vertex 623, the random walk 621 randomly selects the next node to “walk” to. In one embodiment, the selecting can be purely random. For example, the next node from vertex 623 can be one of our options (e.g., W13, W14, W16, or W17). In a purely random approach, there is equal probability that any of the nodes W13, W14, W16, or W16 can be next node. Alternatively, the probability of each node being next can be biased according to the respective edge weight values connecting each node to the vertex 623 (or preceding node in the random walk 621). For example, if the edge weight between the vertex 623 and node W14 is less than the edge weight between the vertex 623 and node W16, then node W16 will have a higher probability of being randomly chosen as the next node in the random walk 621. In this case, node 623 is selected as the next node in the walk.

In one embodiment, the random walk 621 continues until a fixed or predefined number of nodes is traversed. At each subsequent node, each different edge type (e.g., token-to-location edge, token-to-token edge, and/or location-to-location edge) provides a different possibility for continuing the random walk 621. In this way, the random walk 621 can go in between any of the node types or vertices of the hypergraph (e.g., token-to-token, token-to-location, location-to-location, or location-to-token). After the random walk 621 reaches the predetermined number of nodes to traverse (e.g., or meets any other ending criteria such as, but not limited to, doubling back, reaching an end node, etc.), a node sequence 625 of the nodes traversed during the random walk can be provide as an output (e.g., sequence including token node W15, token node W16, location node L2, location node L3, location node 16, and token node W13).

In one embodiment, the graph module 201 can add the output to an artificial corpus of data from which corresponding node embedding data 125 can be generated. The graph module 201 can define a predetermined number of random walks to perform based on an amount of data to achieve a target quality level for the resulting embedding or based on the number of possible random walks that can started from the selected vertex and the predefined number of nodes to traverse in one random walk.

In step 311, the embedding module 205 generates a node embedding (e.g., node embedding data 125) to represent the node corresponding to the selected vertex (e.g., the selected location or token node) based on the one or more node sequences generated by the one or more random walks (e.g., the artificially generated corpus of data).

In one embodiment, the node embedding is generated based on a skip-gram machine learning approach or equivalent. Under this approach, the embedding module 205 can begin by generating a sparse feature representation of the node sequence(s) generated by the random walk(s).

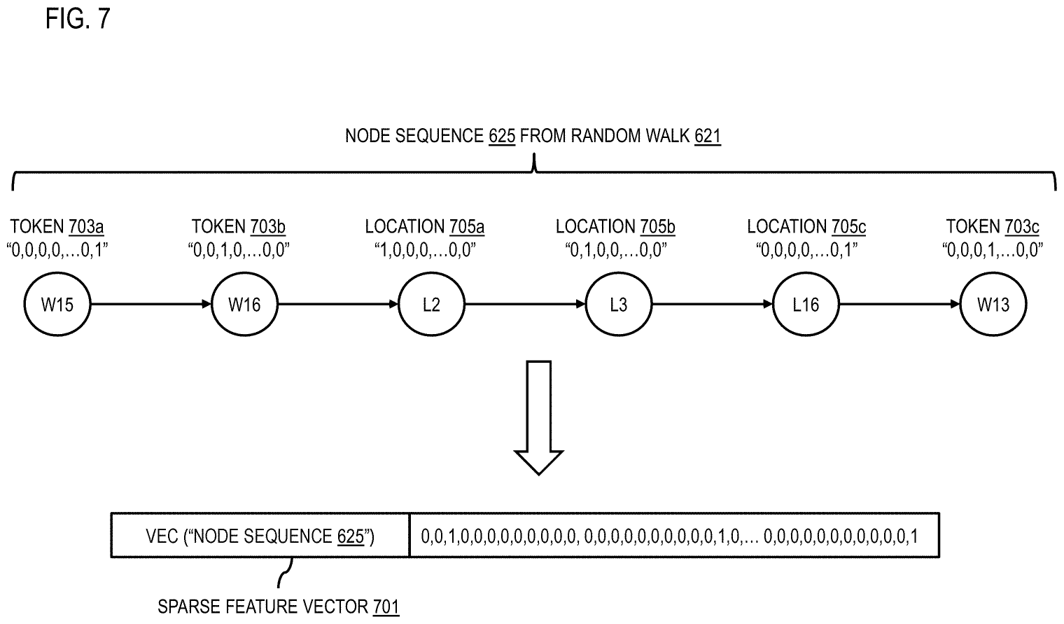

FIG. 7 is a diagram illustrating an example of encoding a sparse feature vector 701 based a node sequence 625 generated from a random walk 621 of hypergraph 601 (as illustrated in the example of FIG. 6B), according to one embodiment. In this example, the node sequence 625 (e.g., as generated by the random walk 621) includes six nodes of hypergraph 601: token node 703a (W15), token node 703b (W16), location node 705a (L2), location node 705b (L3), location node 705c (L16), and token node 703c (W13). The embedding module 205 can then determine label encodings (e.g., binary-encoded labels using one-hot encoding or other encoding scheme) of the attributes or categories respective nodes (e.g., stored in the knowledge graph 401, token graph 501, and/or multi-modal relational location data 101). For example, the labels can indicate what the token is (e.g., token=“menu”) and/or the place categories associated with a location entity (e.g., place category=“Eat and drink”, “Going out entertainment”, etc.). The embedding module 205 can process the encoded labels of the node sequence 625 to create a sparse feature vector 701 for the node sequence 625 (e.g., vec (“node sequence 625”)) by concatenating the encoded labels of each node in the node sequence 625. The feature vector 701 is sparse because the one-hot encoding results in vector containing a value of 0 for the vast majority of the vector elements.

After extracting a feature vector from the node sequence 625 of the random walk 621, the embedding module 205 initiates a processing of the multi-modal relational location data of the node sequence 625 (e.g., represented as the extracted feature vector 701) using a machine learning model 131 selected for creating the node embedding data 125. In one example embodiment, the machine learning model 131 is a skip-gram type model that is trained (e.g., by the learning module 203) to predict a location based on one or more associated location inputs. A skip-gram model, for instance, takes the feature vector of a location's context (e.g., neighbors) or other related attributes and predicts the location. In one use case, the skip-gram model can accept encodings of the spatial relationships of locations or map tile encodings of specific locations' neighbors to predict a specific location on a map tile or other designated geographic area. In short, in an embodiment under this approach, the input is location's context, and the output is the location of interest (e.g., the machine learning model is trained to predict a location based on one or more other locations neighboring or otherwise associated with the location). Therefore, encoding of the input (e.g., a location's context) by the machine learning model performing this type of task can provide a vector representation (e.g., location or node embedding) of the location.

In another example embodiment, the machine learning model is trained to perform a general task based on the input (e.g., trained by the learning module 203). This general task can be any task that uses the feature vector of the node sequence 625 as an input to generate the model's output. For example, the general task can include but is not limited to a location categorization task, a search task, etc.

It is noted that the types of machine learning models described above are provided by way of illustration and not as limitations. It is contemplated that any type of model or training can be applied to the machine learning model for generating the node embedding output. It is noted that the type or extent of training of the machine learning is also not a factor in selecting the machine learning model to use. Instead, in one example embodiment, one selection factor is whether the machine learning operates on the multi-modal relational location data of the node sequence 625 in the feature vector 701 in a way that generates an intermediate representation of the corresponding node of the hypergraph within its hidden layers.

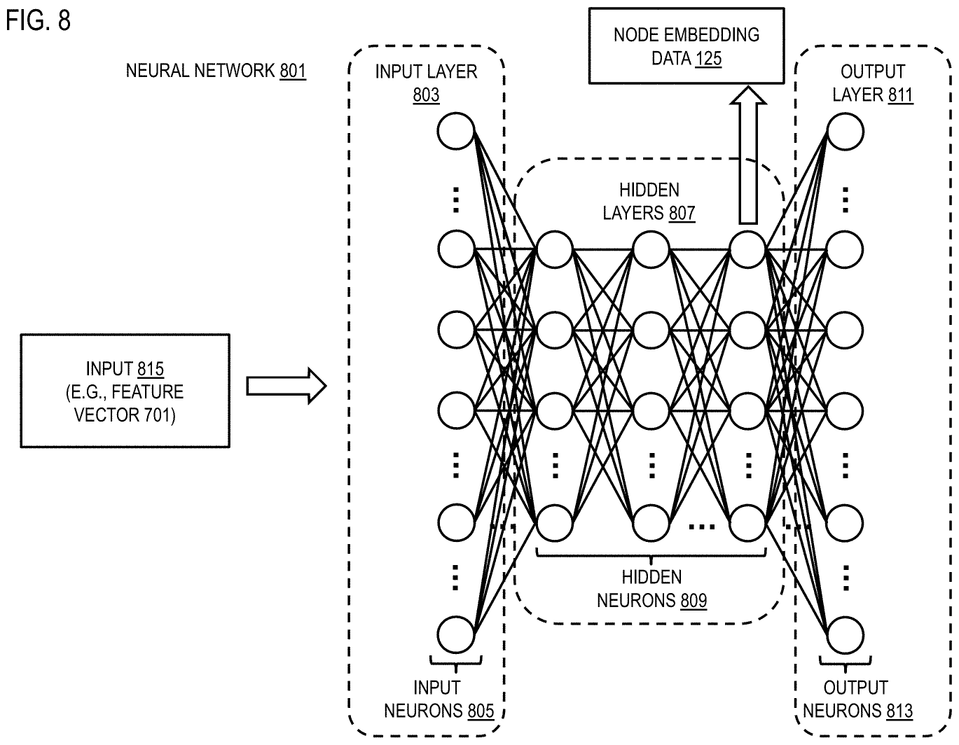

FIG. 8 is a diagram illustrating an example machine learning model from which node embedding (e.g., node embedding data 125) for machine learning tasks can be extracted, according to one embodiment. As shown, the example machine learning model is a neural network 801 that includes an input layer 803 containing input neurons 805, a hidden layer 807 containing hidden neurons 809, and an output layer 811 containing output neurons 813. In this example, the input neurons 805 respectively correspond to one or more input features of input 815 (e.g., the feature vector 701 representing the node sequence 825 of the random walk 821). In the location data domain, the number of features can be quite large (e.g., thousands or tens of thousands of features and corresponding input neurons 805). The hidden layer 807 can contain any number of layers of hidden neurons 809 depending on the selected architecture or application of the network 801. The output layer 811 contains output neurons 813 corresponding to each possible output category. Again, in the location data domain, the potential number categories can significant.

The embedding module 205 feeds the extracted feature vector 701 of input 815 into the input layer 803. In this example, the neural network 801 is trained meaning that the weights and coefficients of the neurons and connection between the neurons of the different layers 803, 807, and 811 have been adjusted to make accurate predictions. The neural network 801 can be a feed forward network that propagates messages from in the input layer 803 through subsequent adjacent layers of the hidden layers 807 and to the output layer. Message propagation through the neural network 801 is determined by respective aggregation and propagation functions at each neuron. So, by providing the input feature vector to the input layer 803, the embedding module 205 causes a cascade of neuronal value updates throughout the network 801 from the input layer 803 towards the output layer 811.

The embedding module 205 can then extract a vector representation of the node sequence 625 (e.g., the node embedding). Extracting, for instance, refers to reading the aggregation function values at each neuron of a selected hidden layer. As shown, the neural network 801 includes three hidden layers 807. In one embodiment, the vector representation of the location can be extracted from the penultimate layer (e.g., the hidden layer immediately preceding the output layer 811). This is because, as messages propagate feed forward through the neural network 801, the encoding of the various attributes of the neurons can be more dense or be associated with more predictive features. It is noted that the features or attributes correspond to respective features, but in many cases the features have been abstracted through the neural network 801 so that the features are not likely to be human understandable (e.g., although they do reflect the position of the location within an N-dimensional feature space of the neural network 801). It is noted, however, although one example embodiment extracts from the penultimate layer, it is contemplated the vector representation to use as a location embedding can be extracted from any of the hidden layers.

By way of example, the vector representation or node embedding is a fixed-length, real-valued vector that encodes one or more attributes of the location. As noted above, the attributes correspond to respective neurons of the hidden layer. Accordingly, in one embodiment, the fixed-length of the vector representation is based on the number of neurons in the hidden layer from which the vector is extracted. For example, if there are 300 neurons in the hidden layer, then the vector will be 300 elements in length with each element corresponding to the aggregation function value of a respective neuron.

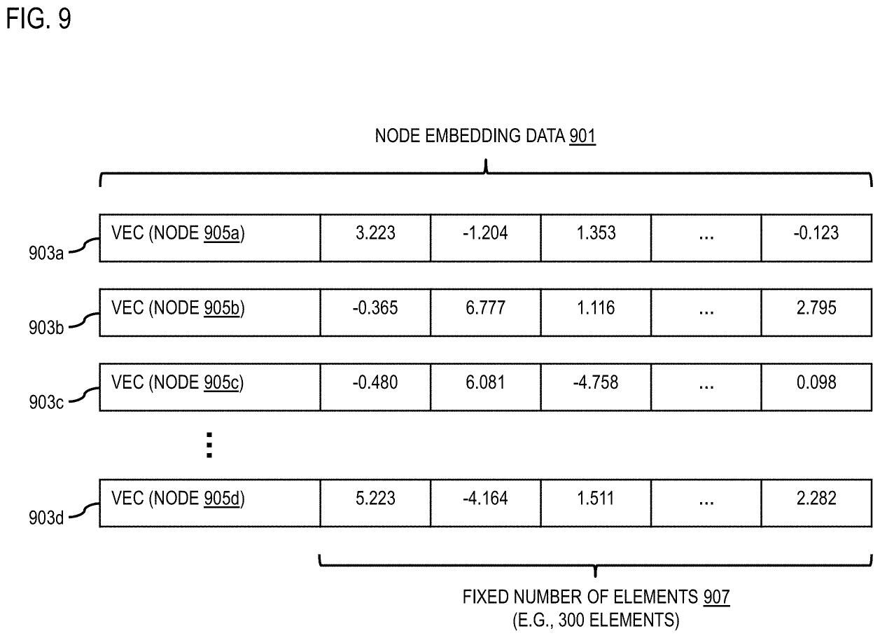

In step 313, the output module 207 provides the node embedding (e.g., node embedding data 125) as an output. FIG. 9 is a diagram illustrating example location embedding data 901, according to one embodiment. As shown, location embedding data 901 includes vectors 903a-903d (also collectively referred to as vectors 903) that respectively represent nodes or node sequences 905a-905d (also collectively referred to nodes 905). In this example, the vectors 903 are labeled to identify the respective nodes 905, followed by a one-dimensional array of attribute elements values extracted from the hidden layer of the embedding machine learning model at a fixed number of elements 907 (e.g., 300 elements). Conceptually, the vector defines the position of the corresponding node of interest within a feature space with a number of dimensions equal to the number elements of the vectors 903 (e.g., 300 elements=a 300 dimension feature space). The distance between each vector in the feature space represents the computed similarity of closeness of locations within the feature space, based on the underlying structure extracted from the multi-modal relational location data 101. Because the underlying structure can include both spatial and semantic relationships, the feature space also can represent both the physical and the semantic relationships of different locations. For example, Washington, DC, and Paris may be similar semantically because they are both capital cities but are physically distant. This latent structural information (among others that may not be human interpretable) can be encoded in the location embeddings

In summary, one example embodiment of the process 300 can be presented as follows for a text data 109 use case:
1. Gather all text features for each node in a constructed hypergraph 127 that enriches a knowledge graph 401 with multi-modal relational location data 101 (e.g., unstructured text data, images, etc.).
2. Preprocess the text; e.g., the system 100 reads each source of text or other data using techniques such as, but not limited to, an NLP pipeline (e.g., SpaCY) and retain noun phrases. This allows one embodiment of the process 300 to focus primarily on salient text, and has the additional impact of removing inappropriate tokens (e.g., script tags from web pages).
3. Calculate TF-IDF values for each token in the processed text for each KG node.
4. Add each text token (e.g., that satisfies a minimum TF-IDF threshold) to the hypergraph 127 such that it is connected to all entities whose text features have that token present.
5. Each edge connecting a knowledge graph node with a text node is weighted by the corresponding TF-IDF value (0-1).
6. Compute cosine similarity (or equivalent similarity value) between pretrained token embeddings (e.g., using the same NLP pipeline used above) for N random pairs of token nodes. In one embodiment, N nodes are selected, rather than the entire Vocabulary×Vocabulary number of edges, as a practical implementation choice to reduce time and resource consumption for computing similarity.
7. Each of the N edges connecting a text node with another is weighted by the corresponding cosine similarity values (0-1) or equivalent.
8. Run biased random walks (to account for edge weights) to generate an artificial corpus of data as described above.
9. Generate node embeddings using the skip-gram model or equivalent.
10. Use the node embedding data 125 for downstream machine learning tasks 135.

In one embodiment, as indicated above, the output module 207 can provide the location embedding output as an input to one or more downstream machine learning tasks 135. In this way, the downstream machine learning tasks 135 can benefit from the already encoded node embedding data 125. The node embedding output can be provided in any data structure or format. For example, the vectors can be presented as list in a text file that can be ingested by the downstream machine learning tasks 135.

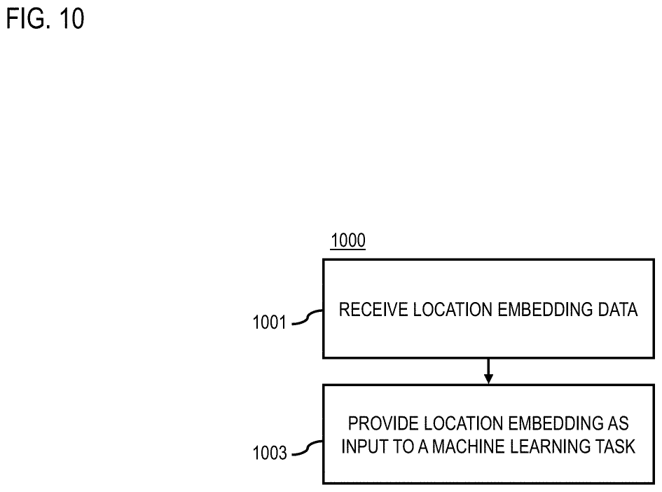

FIG. 10 is a flowchart of a process 1000 for using a location embedding for a machine learning task, according to one embodiment. In various embodiments, the machine learning system 129 and/or any of the modules 201-207 may perform one or more portions of the process 1000 and may be implemented in, for instance, a chip set including a processor and a memory as shown in FIG. 14. As such, the machine learning system 129 and/or any of the modules 201-207 can provide means for accomplishing various parts of the process 1000, as well as means for accomplishing embodiments of other processes described herein in conjunction with other components of the system 100. Although the process 1000 is illustrated and described as a sequence of steps, it is contemplated that various embodiments of the process 1000 may be performed in any order or combination and need not include all of the illustrated steps.

In step 1001, embedding module 205 (e.g., of a machine learning system associated with a downstream machine learning task 135) receives a node embedding comprising a vector representation. The node embedding is generated by extracting the vector representation from a hidden layer of an upstream machine learning model that processed a random walk of a hypergraph according to the process 300 of FIG. 3 above. As used herein, the term “upstream” refers to a machine learning model that generated the location embedding before providing it to the downstream machine learning task 135.

In step 1003, the embedding module 205 provides the node embedding as an input to a machine learning task. In one embodiment, the machine learning task is “downstream” relative to (e.g., occurring after) the creation of the node embedding. It is contemplated that the machine learning task can used any machine learning model or approach provided that the output of the machine learning task is generated based, at least in part, on the node embedding. In other words, the machine learning task is performed based, at least in part, on the encoded attributes of the vector representations of locations in the embedding data.

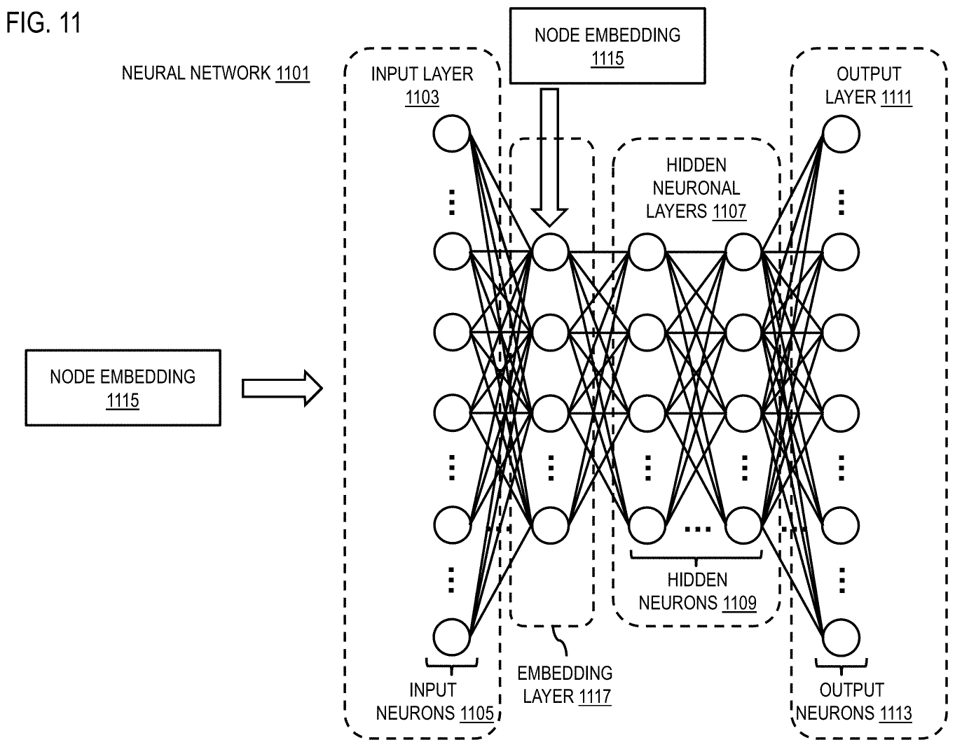

It is contemplated that the machine learning task can input the node embedding to its machine learning model using any means as illustrated in FIG. 11. FIG. 11 is a diagram illustrating an example neural network capable of using a location embedding, according to one embodiment. The neural network 1101 is similar in structure to the neural network 801 of FIG. 8 and includes an input layer 1103 containing input neurons 1105, hidden layers 1107 containing hidden neurons 1109, and an output layer 1111 containing output neurons 1113.

In one example embodiment, a received node embedding 1115 (e.g., node embedding data 125) can be used as a direct input into the machine learning task (e.g., the neural network 1101). The direct input, for instance, feeds the vector representation in the input layer 1103. The node embedding 1115 may optionally be fed in with other input features applicable to the specific machine learning task being performed.

In another example embodiment, the node embedding 1115 can be input or otherwise included in an embedding layer 1117 of the machine learning task (e.g., neural network 1101). For example, if the node embedding 1115 includes a large number of node sequence vector representations, it may be more efficient to include the location embedding 1115 in the embedding layer 1117. Although the embedding layer 1117 is depicted as the first layer after the input layer 1103, it is contemplated that the embedding layer 1117 may be included at any other layer of the neural network 1101. In some embodiments, multiple embedding layers 1117 may be included in the neural network (e.g., different embedding layers at different resolutions, or associated with different domains, services, etc.).

Returning to FIG. 1, as shown, the system 100 includes a machine learning system 129 for providing a generalizable semantic-aware location representation for machine learning tasks according to the various embodiments described herein. In one embodiment, the machine learning system 129 includes or is otherwise associated with one or more machine learning models 131 (e.g., neural networks or other equivalent network) for generating node embeddings. The machine learning models 131 can also be used as part of a computer vision system for detecting new or updated places through image analysis.

In one embodiment, the machine learning system 129 has connectivity over the communication network 133 to the mapping platform 107, services platform 111 that provides one or more services 113 that can use node embedding data 125 for downstream machine learning tasks 135 to perform one or more functions. By way of example, the services 113 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 113 uses the output of the machine learning system 129 (e.g., location embeddings) to provide services 113 such as navigation, mapping, other location-based services, etc. to the vehicles 119, UEs 121, and/or applications 123 executing on the UEs 121.

In one embodiment, the machine learning system 129 may be a platform with multiple interconnected components. The machine learning system 129 may include multiple servers, intelligent networking devices, computing devices, components, and corresponding software for providing location embeddings according to the various embodiments described herein. In addition, it is noted that the machine learning system 129 may be a separate entity of the system 100, a part of the mapping platform 107, one or more services 113, a part of the services platform 111, or included within components of the vehicles 119 and/or UEs 121.

In one embodiment, content providers 115 may provide content or data (e.g., including geographic data, etc.) to the geographic database 103, machine learning platform 128, the mapping platform 107, the services platform 111, the services 113, the vehicles 119, the UEs 121, and/or the applications 123 executing on the UEs 121. The content provided may be any type of content, such as machine learning models, map embeddings, map content, textual content, audio content, video content, image content, etc. In one embodiment, the content providers 115 may provide content that may aid in providing location embeddings according to the various embodiments described herein. In one embodiment, the content providers 115 may also store content associated with the machine learning system 129, geographic database 103, mapping platform 107, services platform 111, services 113, and/or any other component of the system 100. In another embodiment, the content providers 115 may manage access to a central repository of data, and offer a consistent, standard interface to data, such as a repository of the geographic database 103.

In one embodiment, the vehicles 119 and/or UEs 121 may execute software applications 123 to detect map features/objects for node embedding according the embodiments described herein. By way of example, the applications 123 may also be any type of application that is executable on the vehicles 119 and/or UEs 121, such as autonomous driving applications, mapping applications, location-based service applications, navigation applications, device control applications, content provisioning services, camera/imaging application, media player applications, social networking applications, calendar applications, and the like. In one embodiment, the applications 123 may act as a client for the mapping platform 107 and perform one or more functions associated with providing node embeddings alone or in combination with the mapping platform 107.

By way of example, the vehicles 119 and/or UEs 121 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 119 and/or UEs 121 can support any type of interface to the user (such as “wearable” circuitry, etc.). In one embodiment, the vehicles 119 and/or UEs 121 may be associated with or be a component of a vehicle or any other device.

In one embodiment, the vehicles 119 and/or UEs 121 are configured with various sensors for generating or collecting environmental image data (e.g., multi-modal relational location data for processing by machine learning system 129), related geographic data, etc. In one embodiment, the sensed data represent sensor data associated with a geographic location or coordinates at which the sensor data was collected, and the polyline or polygonal representations of detected objects of interest derived therefrom. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 119 and/or UEs 121 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 119 and/or UEs 121 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 119 and/or UEs 121 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 133 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the machine learning system 129, mapping platform 107, services platform 111, services 113, vehicles 119 and/or UEs 121, and/or content providers 115 communicate with each other and other components of the system 100 using well known, new or still developing protocols. In this context, a protocol includes a set of rules defining how the network nodes within the communication network 133 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

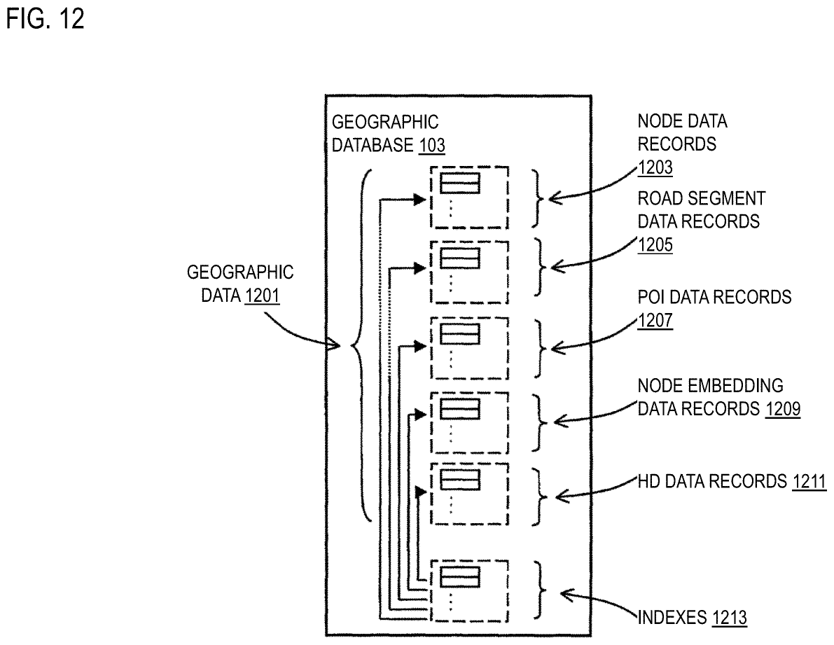

FIG. 12 is a diagram of a geographic database 103, according to one embodiment. In one embodiment, the geographic database 103 includes geographic data 1201 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1201. In one embodiment, the geographic database 103 include high definition (HD) mapping data that provide centimeter-level or better accuracy of map features. For example, the geographic database 103 can be based on Light Detection and Ranging (LiDAR) or equivalent technology to collect billions of 3D points and model road surfaces and other map features down to the number lanes and their widths. In one embodiment, the HD mapping data (e.g., HD data records 1211) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 103.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 103 follows certain conventions. For example, links do not cross themselves and do not cross each other except at a node. Also, there are no duplicated shape points, nodes, or links. Two links that connect each other have a common node. In the geographic database 103, overlapping geographic features are represented by overlapping polygons. When polygons overlap, the boundary of one polygon crosses the boundary of the other polygon. In the geographic database 103, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 103 includes node data records 1203, road segment or link data records 1205, POI data records 1207, node embedding data records 1209, HD mapping data records 1211, and indexes 1213, for example. More, fewer, or different data records can be provided. In one embodiment, additional data records (not shown) can include cartographic (“cartel”) data records, routing data, and maneuver data. In one embodiment, the indexes 1213 may improve the speed of data retrieval operations in the geographic database 103. In one embodiment, the indexes 1213 may be used to quickly locate data without having to search every row in the geographic database 103 every time it is accessed. For example, in one embodiment, the indexes 1213 can be a spatial index of the polygon points associated with stored feature polygons.

In exemplary embodiments, the road segment data records 1205 are links or segments representing roads, streets, or paths, as can be used in the calculated route or recorded route information for determination of one or more personalized routes. The node data records 1203 are end points (for example, representing intersections or an end of a road) corresponding to the respective links or segments of the road segment data records 1205. The road link data records 1205 and the node data records 1203 represent a road network, such as used by vehicles, cars, and/or other entities. Alternatively, the geographic database 103 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 103 can include data about the POIs and their respective locations in the POI data records 1207. The geographic database 103 can also include data about places, such as cities, towns, or other communities, and other geographic features, such as bodies of water, mountain ranges, etc. Such place or feature data can be part of the POI data records 1207 or can be associated with POIs or POI data records 1207 (such as a data point used for displaying or representing a position of a city).

In one embodiment, the geographic database 103 can also include node embedding data records 1209 for node embeddings, location graphs, machine learning model parameters, and/or any other related data that is used or generated according to the embodiments described herein. By way of example, the node embedding data records 1209 can be associated with one or more of the node records 1203, road segment records 1205, and/or POI data records 1207 to associate the semantic category predictions with specific places, POIs, geographic areas, and/or other map features. In this way, the semantic category data records 1209 can also be associated with the characteristics or metadata of the corresponding records 1203, 1205, and/or 1207.

In one embodiment, as discussed above, the HD mapping data records 1211 model road surfaces and other map features to centimeter-level or better accuracy. The HD mapping data records 1211 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1211 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1211 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1211.

In one embodiment, the HD mapping data records 1211 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 103 can be maintained by the content provider 115 in association with the services platform 111 (e.g., a map developer). The map developer can collect geographic data to generate and enhance the geographic database 103. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 103 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicles 119 and/or UEs 121. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing location embeddings may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

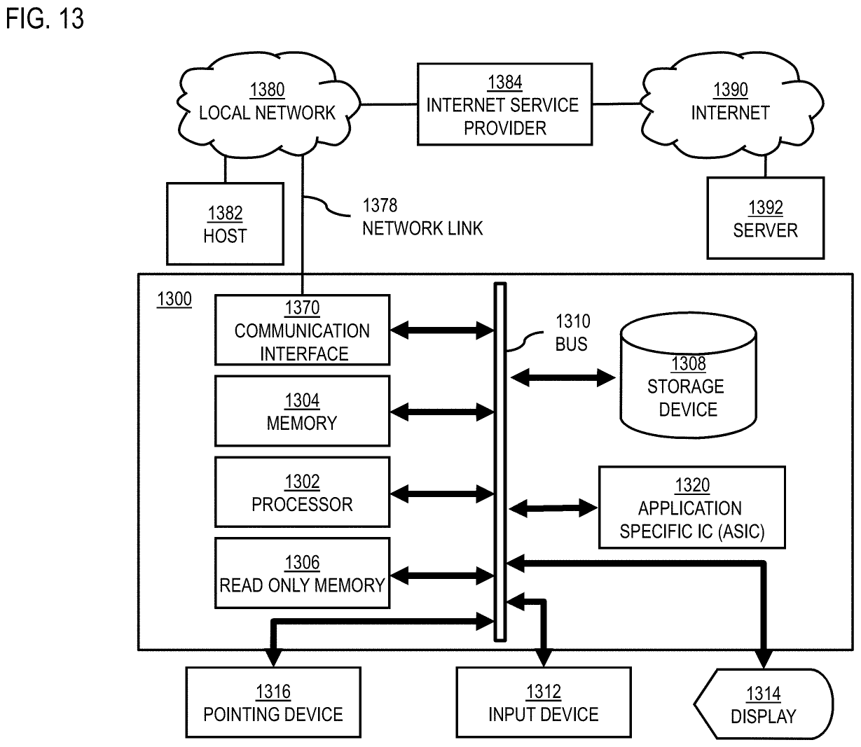

FIG. 13 illustrates a computer system 1300 upon which an embodiment of the invention may be implemented. Computer system 1300 is programmed (e.g., via computer program code or instructions) to provide location embeddings as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1310 includes one or more parallel conductors of information so that information is transferred quickly among devices coupled to the bus 1310. One or more processors 1302 for processing information are coupled with the bus 1310.

A processor 1302 performs a set of operations on information as specified by computer program code related to providing location embeddings. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RANI) or other dynamic storage device, stores information including processor instructions for providing location embeddings. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for providing location embeddings, is provided to the bus 1310 for use by the processor from an external input device 1312, such as a keyboard containing alphanumeric keys operated by a human user, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT) or a liquid crystal display (LCD), or plasma screen or printer for presenting text or images, and a pointing device 1316, such as a mouse or a trackball or cursor direction keys, or motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners, and external disks. In general, the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic, or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 133 for providing location embeddings.

The term computer-readable medium is used herein to refer to any medium that participates in providing information to processor 1302, including instructions for execution. Such a medium may take many forms, including, but not limited to, non-volatile media, volatile media, and transmission media. Non-volatile media include, for example, optical or magnetic disks, such as storage device 1308. Volatile media include, for example, dynamic memory 1304. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system can be deployed in various configurations within other computer systems, e.g., host 1382 and server 1392.

FIG. 14 illustrates a chip set 1400 upon which an embodiment of the invention may be implemented. Chip set 1400 is programmed to provide location embeddings as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to provide location embeddings. The memory 1405 also stores the data associated with or generated by the execution of the inventive steps.

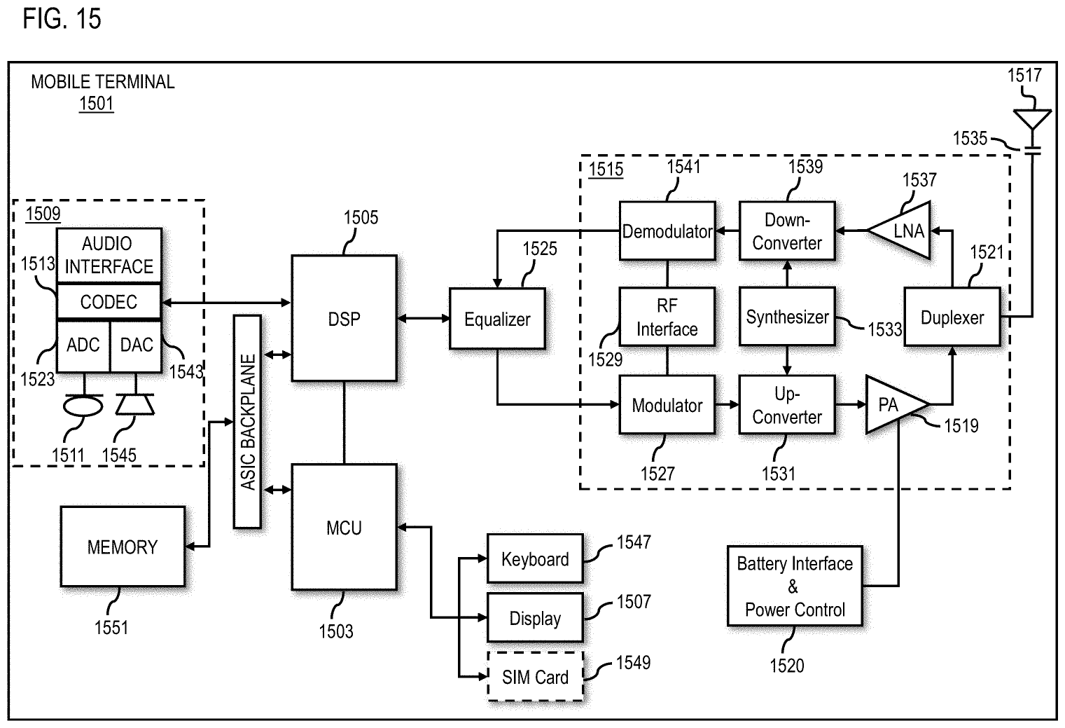

FIG. 15 is a diagram of exemplary components of a mobile terminal 1501 (e.g., a vehicle 119 and/or UE 121 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile station functions that offer automatic contact matching. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile station 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503—which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile station 1501 to provide location embeddings. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the station. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile station 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1551 may be, but not limited to, a single memory, CD, DVD, ROM, RAM, EEPROM, optical storage, or any other non-volatile or non-transitory storage medium capable of storing digital data.

An optionally incorporated SIM card 1549 carries, for instance, important information, such as the cellular phone number, the carrier supplying service, subscription details, and security information. The SIM card 1549 serves primarily to identify the mobile station 1501 on a radio network. The card 1549 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
receiving a knowledge graph that represents a plurality of location entities as a plurality of location nodes and represents relationship information between the plurality of location nodes as a plurality of location edges;
processing multi-modal data associated with the plurality of location entities to determine a plurality of tokens;
creating a hypergraph that represents the plurality of tokens as a plurality of token nodes, wherein the hypergraph includes: (1) a first edge type that relates a token node of the plurality of token nodes to a location node of the plurality of location nodes of the knowledge graph, and (2) a second edge type that relates a first token node to a second token node of the plurality of token nodes;
selecting a vertex of the hypergraph that corresponds to a node of either the plurality of token nodes or the plurality of location nodes;
performing a random walk of the hypergraph based on the selected vertex to generate a node sequence comprising a subset of one or more nodes of the hypergraph;
generating a node embedding to represent the node corresponding to the vertex based on the node sequence; and
providing the node embedding as an output.

2. The method of claim 1, wherein the multi-modal data is unstructured text data, and wherein the plurality of tokens is a plurality of words of in the unstructured text data.

3. The method of claim 2, wherein the plurality of words is a plurality of nouns occurring in the unstructured text data.

4. The method of claim 1, further comprising:
selecting the plurality of tokens to include in the hypergraph based on token frequency data.

5. The method of claim 4, further comprising:
weighting the first edge type between the token node and the location node based on the token frequency data.

6. The method of claim 5, wherein the token frequency data is based on a term frequency-inverse document frequency (TF-IDF) value.

7. The method of claim 1, further comprising:
weighting the second edge type based on a token similarity value between the first token node and the second token node.

8. The method of claim 7, wherein the token similarity value is computed for a predefined number of random pairs of the plurality of tokens.

9. The method of claim 1, wherein the random walk is biased based on one or more edge weight values of the one or more edges of the hypergraph.

10. The method of claim 1, wherein the node embedding is generated based on a skip-gram machine learning approach.

11. The method of claim 10, wherein the node embedding is a vector representation extracted from a hidden layer of a machine learning model applying the skip-gram machine learning approach.

12. The method of claim 1, wherein the multi-modal data is image data, and wherein the plurality of tokens is a plurality of image objects detected in the image data.

13. An apparatus comprising:
at least one processor; and
at least one memory including computer program code for one or more programs,
the at least one memory and the computer program code configured to, within the at least one processor, cause the apparatus to perform at least the following,
receive a knowledge graph that represents a plurality of location entities as a plurality of location nodes and represents relationship information between the plurality of location nodes as a plurality of location edges;
process multi-modal data associated with the plurality of location entities to determine a plurality of tokens;
create a hypergraph that represents the plurality of tokens as a plurality of token nodes, wherein the hypergraph includes: (1) a first edge type that relates a token node of the plurality of token nodes to a location node of the plurality of location nodes of the knowledge graph, and (2) a second edge type that relates a first token node to a second token node of the plurality of token nodes;
select a vertex of the hypergraph that corresponds to a node of either the plurality of token nodes or the plurality of location nodes;
perform a random walk of the hypergraph based on the selected vertex to generate a node sequence comprising a subset of one or more nodes of the hypergraph;
generate a node embedding based on the node sequence; and
provide the node embedding as an output.

14. The apparatus of claim 13, wherein the multi-modal data is unstructured text data, and wherein the plurality of tokens is a plurality of words of in the unstructured text data.

15. The apparatus of claim 14, wherein the plurality of words is a plurality of nouns occurring in the unstructured text data.

16. The apparatus of claim 13, wherein the apparatus is further caused to:
select the plurality of tokens to include in the hypergraph based on token frequency data.

17. A non-transitory computer-readable storage medium for providing map embedding analytics for a neural network, carrying one or more sequences of one or more instructions which, when executed by one or more processors, cause an apparatus to perform:
receiving a knowledge graph that represents a plurality of location entities as a plurality of location nodes and represents relationship information between the plurality of location nodes as a plurality of location edges;
processing multi-modal data associated with the plurality of location entities to determine a plurality of tokens;
creating a hypergraph that represents the plurality of tokens as a plurality of token nodes, wherein the hypergraph includes: (1) a first edge type that relates a token node of the plurality of token nodes to a location node of the plurality of location nodes of the knowledge graph, and (2) a second edge type that relates a first token node to a second token node of the plurality of token nodes;
selecting a vertex of the hypergraph that corresponds to a node of either the plurality of token nodes or the plurality of location nodes;
performing a random walk of the hypergraph based on the selected vertex to generate a node sequence comprising a subset of one or more nodes of the hypergraph;
generating a node embedding based on the node sequence; and
providing the node embedding as an output.

18. The non-transitory computer-readable storage medium of claim 17, wherein the multi-modal data is unstructured text data, and wherein the plurality of tokens is a plurality of words of in the unstructured text data.

19. The non-transitory computer-readable storage medium of claim 18, wherein the plurality of words is a plurality of nouns occurring in the unstructured text data.

20. The non-transitory computer-readable storage medium of claim 17, wherein the apparatus is caused to further perform:
selecting the plurality of tokens to include in the hypergraph based on token frequency data.
